(19) United States
(12) Patent Application Publication
(10) Pub. No.: US 2013/0226725 A1
(43) Pub. Date: Aug. 29, 2013

(54) RESPONSES TO REQUESTS FOR PROPOSALS

(71) Applicants: Michael J. Melone, Middletown, DE (US); Jeanne McManaman, Wilmington, DE (US)

(72) Inventors: Michael J. Melone, Middletown, DE (US); Jeanne McManaman, Wilmington, DE (US)

(73) Assignee: Barclays Bank Delaware, Wilmington, DE (US)

(21) Appl. No.: 13/403,437

(22) Filed: Feb. 23, 2012

(51) Int. Cl. G06Q 30/06

(52) U.S. Cl. 705/26.4

(57) ABSTRACT

Various embodiments are described relating to systems for responding to RFPs and processes for making the same. The systems can include a container storing multiple recordable media containing information for responding to an RFP. The recordable media can be of different types. The information stored in each recordable media can be the same or only a portion of the information stored in each recordable media can be the same. The container and recordable media can be configured to identify the recipient of the system using, for example, colors, logos, words, structures, or the like (or combinations thereof).

### BACKGROUND

1. Field

The present application relates generally to packaging and, more particularly, to packaging responses to requests for proposals.

2. Related Art

During the procurement process for a good or service, companies typically issue requests for proposals (RFPs) to prospective suppliers. In response to receiving an RFP, suppliers submit bids or proposals containing information that explains why that particular supplier is the best candidate to provide the good or service. Based on the received responses to the RFP, the issuing company can select which, if any, supplier they would like to do business with.

Since the company issuing the RFP relies heavily on the material contained in the response to the RFP to make their selection, suppliers spend a great deal of money and effort assembling these responses in an attempt to distinguish themselves from their competitors. For example, suppliers may submit elaborate printed documentation that provides financial data showing the amount of money that can be saved if the company issuing the RFP selects them as their supplier. However, the difficulty with responding to RFPs is that there are typically many other suppliers submitting the same type of information. This makes it very difficult for a supplier to stand out from its peers.

### SUMMARY

Systems for responding to RFPs are disclosed. In one exemplary embodiment, the systems can include a container storing multiple recordable media containing information for responding to an RFP. The recordable media can be of different types. For example, the recordable media can include printed materials (e.g., a booklet, pamphlet, brochure, coupon, application, or the like), an electronic storage medium (e.g., a compact disk (CD), DVD, Blue-ray disk, flash memory, or the like), portable electronic media player, or a portable computing device (e.g., touch-sensitive tablet, laptop, or the like). In some embodiments, each of the recordable media can include the same information, allowing a recipient of the system to view the information in any desired format. In other embodiments, at least a portion of the information contained in each of the recordable media can be the same. The container and recordable media can be configured to identify the recipient of the system using colors, logos, words, structures, and the like (and combinations thereof).

Processes for making systems for responding to RFPs are also disclosed.

### DESCRIPTION OF THE FIGURES

FIG. 1 illustrates a perspective view of an exemplary system for responding to an RFP.

FIG. 2 illustrates another perspective view of an exemplary system for responding to an RFP.

FIG. 3 illustrates another perspective view of an exemplary system for responding to an RFP.

FIG. 4 illustrates another perspective view of an exemplary system for responding to an RFP.

FIG. 5 illustrates another perspective view of an exemplary system for responding to an RFP.

FIG. 6 illustrates another perspective view of an exemplary system for responding to an RFP.

FIG. 7 illustrates another perspective view of an exemplary system for responding to an RFP.

FIG. 8 illustrates an exemplary process for assembling a system for responding to an RFP.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below relating to systems for responding to RFPs and processes for making the same. The systems can include a container storing multiple recordable media containing information for responding to an RFP. The recordable media can be of different types. For example, the recordable media can include printed materials (e.g., a booklet, pamphlet, brochure, coupon, application, or the like), an electronic storage medium (e.g., a CD, DVD, Blue-ray disk, flash memory, or the like), portable electronic media player, or a portable computing device (e.g., touch-sensitive tablet, laptop, or the like). In some embodiments, each of the recordable media can include the same information, allowing a recipient of the system to view the information in any desired format. In other embodiments, only a portion of the information contained in each of the recordable media can be the same. The container and recordable media can be configured to identify the recipient of the system using, for example, colors, logos, words, structures, or combinations thereof. While the various embodiments are described below using the credit card industry as an example, it should be appreciated that the embodiments can similarly be applied to RFPs in any commercial industry.

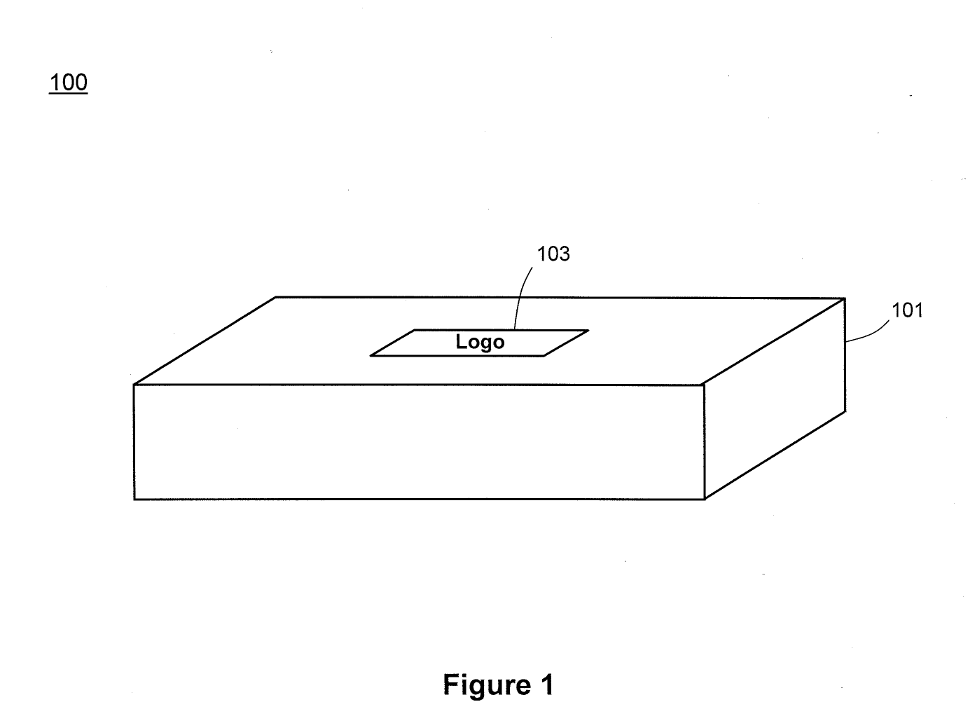

FIG. 1 illustrates an exemplary system 100 for responding to an RFP. System 100 can include container 101 for storing recordable media, sample products, and the like. Container 101 can be formed from any rigid material, such as cardboard, plastic, metal, or the like. Alternatively, in other embodiments, container 101 can be a bag formed from any non-rigid material, such as cotton, nylon, leather, or other materials conventionally used to make bags. Additionally, while container 101 is shown as a rectangular box, it should be appreciated that container 101 can be formed into any shape capable of storing the contents of system 100. For example, container 101 can alternatively be cylindrical in shape.

In some embodiments, container 101 can include one or more logos 103 on one or more of its surfaces. Logo 103 can include a graphic design or image, words, or combinations thereof. Logo 103 can be printed onto container 101 or can be formed from additional materials adhered to the surface of container 101 to generate the desired design or pattern. In some embodiments, logo 103 can include a graphic design or image, words, or combinations thereof that are associated with the recipient (client or company issuing the RFP) of system 100. For example, logo 103 can include the logo, slogan, phrase, or combinations thereof, used by the client. Additionally, in some embodiments, the materials used to form the surfaces of container 101 can be configured to have colors or designs that are associated with the client. For example, the surfaces of container 101 can be colored using the same colors that the client uses to identify itself (e.g., in its logo or on its products). In this way, container 101 can be configured to identify the client that issued the RFP.

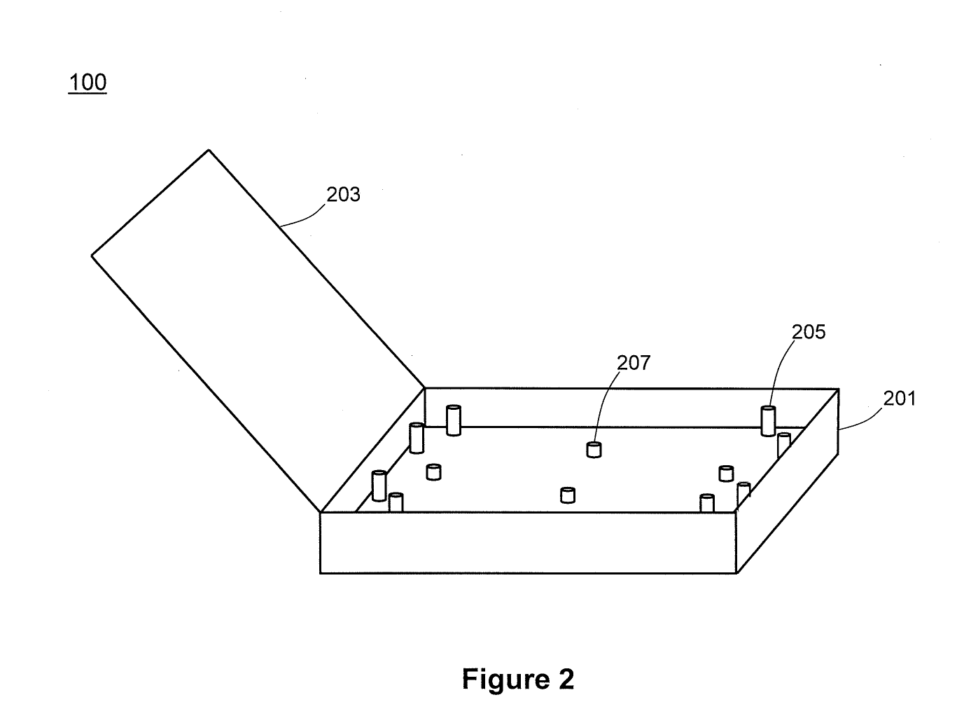

FIG. 2 illustrates a perspective view of one example container 201 that can be used as container 101 of FIG. 1. Container 201 includes a hinged cover 203 that can be lifted to expose the contents of container 201. In other embodiments, cover 203 can be completely removable from the bottom portion of container 201. Container 201 further includes support members 205 and 207 configured to support one or more recordable mediums. In the illustrated embodiment, support members 205 and 207 include cylinders of varying heights. Specifically, support members 205 have a uniform, or at least substantially uniform, height that is greater than that of support members 207, which also have a uniform, or at least substantially uniform, height. Support members 205 can be positioned along the edge of container 201 with support members 207 positioned within the interior of support members 205. While support members 205 and 207 are shown as cylinders, they can be formed into any desired shape. For example, in some embodiments, support members 205 and 207 can be configured so as to identify a client. Support members 205 and 207 can be formed into a shape associated with the client (e.g., their logo) and colored using colors that the client uses to identify themself.

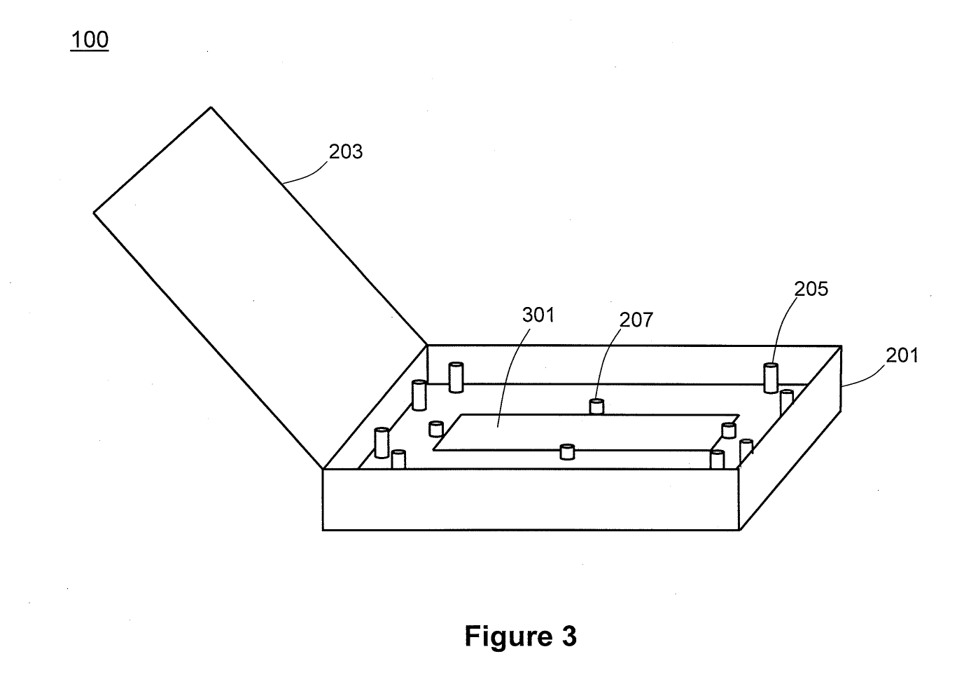

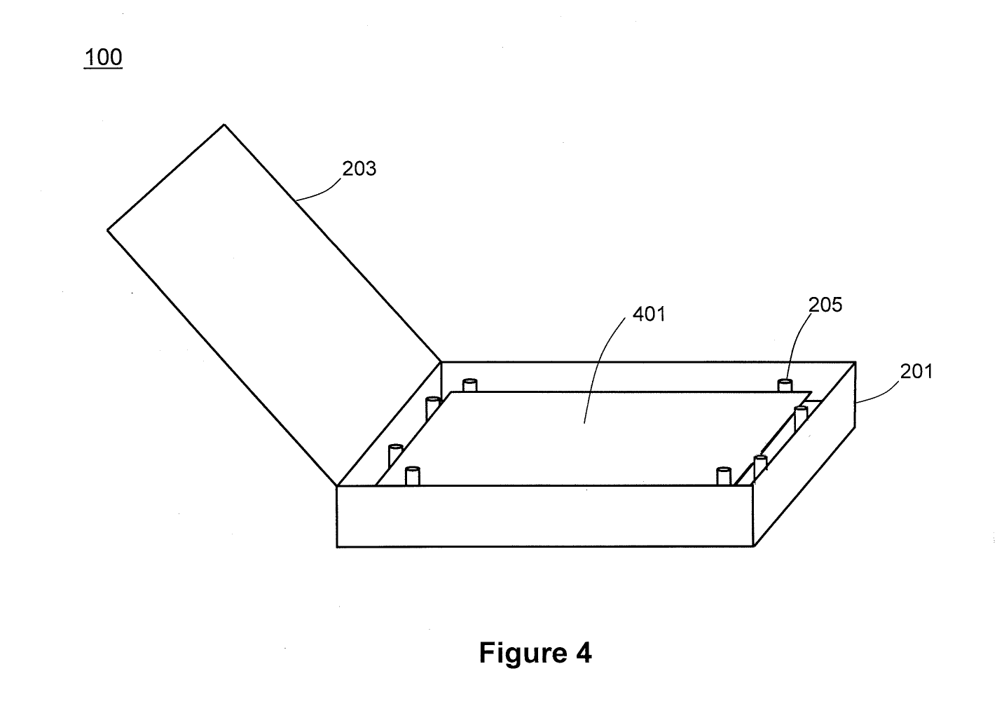

In some embodiments, a first recordable medium 301 can be positioned and secured between support members 207, as shown in FIG. 3. As described above, first recordable medium 301 can include any type of storage medium, such as printed materials, electronic storage media, a portable computing device, or the like. Additionally, a second recordable medium 401 can be positioned above first recordable medium 301 and supported below by support members 207 and secured in place with support members 205, as shown in FIG. 4.

In one exemplary embodiment, first recordable medium 301 can include a portable computing device, such as a touch-sensitive tablet, cellular phone, or the like. The second recordable medium 401 can include printed materials, such as a booklet, pamphlet, brochure, or the like. In some embodiments, a third recordable medium (not shown) can be attached to, or included within, second recordable medium 401. For example, a CD, DVD, Blue-ray disk, or the like, can be affixed (e.g., using an adhesive) to a cover of second recordable medium 401 or inserted within a sleeve affixed to second recordable medium 401. As described above, some or all of the recordable media within container 201 can be configured to identify the client that submitted the RFP. For example, the client's name, logo, color(s), phrase associated with the client, or the like (or combinations thereof), can be affixed to some or all of the recordable media.

The contents of the recordable media can include information for responding to a specific RFP. For example, if the RFP is requesting proposals for a credit card service, the recordable media can include information regarding the supplier's management team, experience, history, contractual terms, financial bid, and any other information that can be used to describe the supplier's service or product and to distinguish the supplier from other vendors. In some embodiments, each of the recordable media stored in container 201 can be the same. For example, first recordable medium 301 and the third recordable medium may contain electronic versions of the printed materials of second recordable medium 401. In some examples, first recordable medium 301 and the third recordable medium may include interactive electronic versions of the printed materials of second recordable medium 401. In other embodiments, only a portion of the information stored in the first, second, and third recordable media may be the same. For example, each of the first, second, and third recordable media may include information about the contractual terms and the financial bid, but some or all of the recordable media may include information that is not included in each of the other recordable media. In yet other embodiments, the information stored in the first, second, and third recordable media can be different. For example, the first recordable media can include a paper copy of the contractual terms and the financial bid, the second recordable media can include a video, and the third recordable media can include images of the product.

In some embodiments, container 201 can further include a sample of the product of service offered by the originator of container 201 (i.e., the supplier). For instance, using the credit card example described above, the sample product can include a credit card issued to the client and identified with the client's name, logo, color(s), phrase associated with the client, or the like (or combinations thereof). The credit card can be an active credit card that can be used by the client or can be an inactive card provided for the sole purpose of showing the product that would be received if the client engaged in business with the supplier. The product (e.g., a credit card) can be placed anywhere within container 201. For example, it can be affixed to one of the recordable mediums or otherwise held in place within container 201.

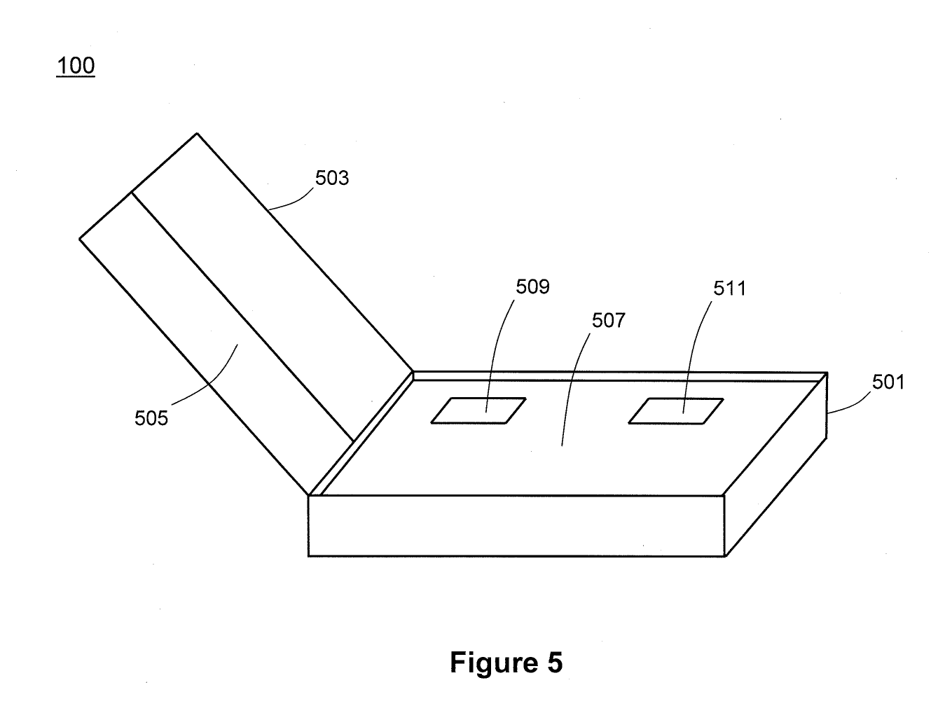

FIG. 5 illustrates a perspective view of another example container 501 that can be used as container 101 of FIG. 1. Similar to container 201, container 501 includes a hinged cover 503 that can be lifted to expose the contents of container 501. In other embodiments, cover 503 can be completely removable from the bottom portion of container 501. Cover 503 can include a pocket or sleeve 505 configured to store a recordable medium (e.g., brochure, pamphlet, CD, DVD, or the like) or a sample product (e.g., a credit card).

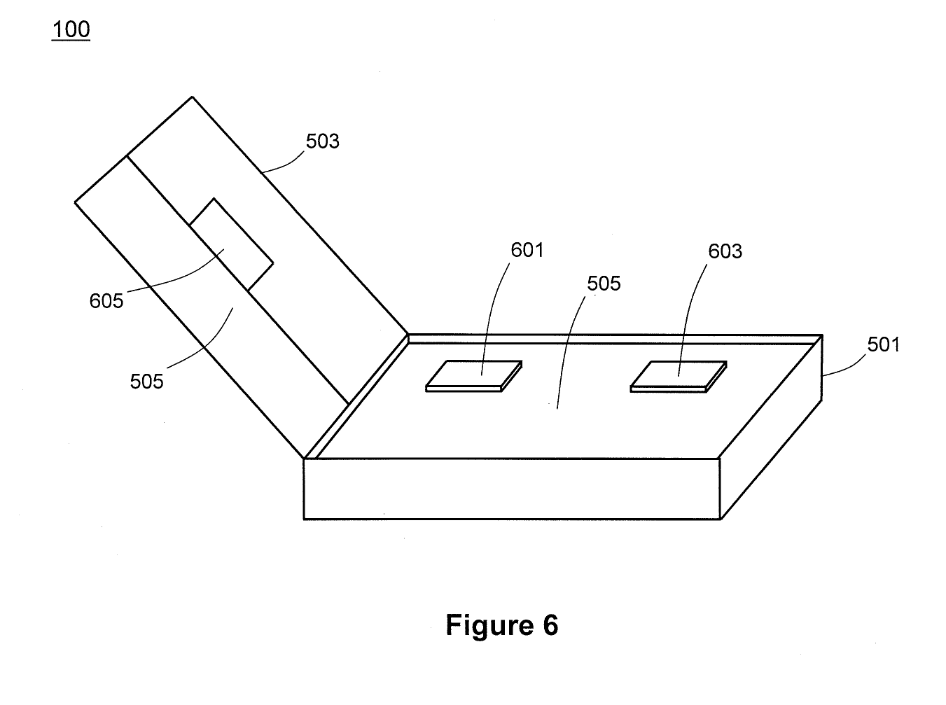

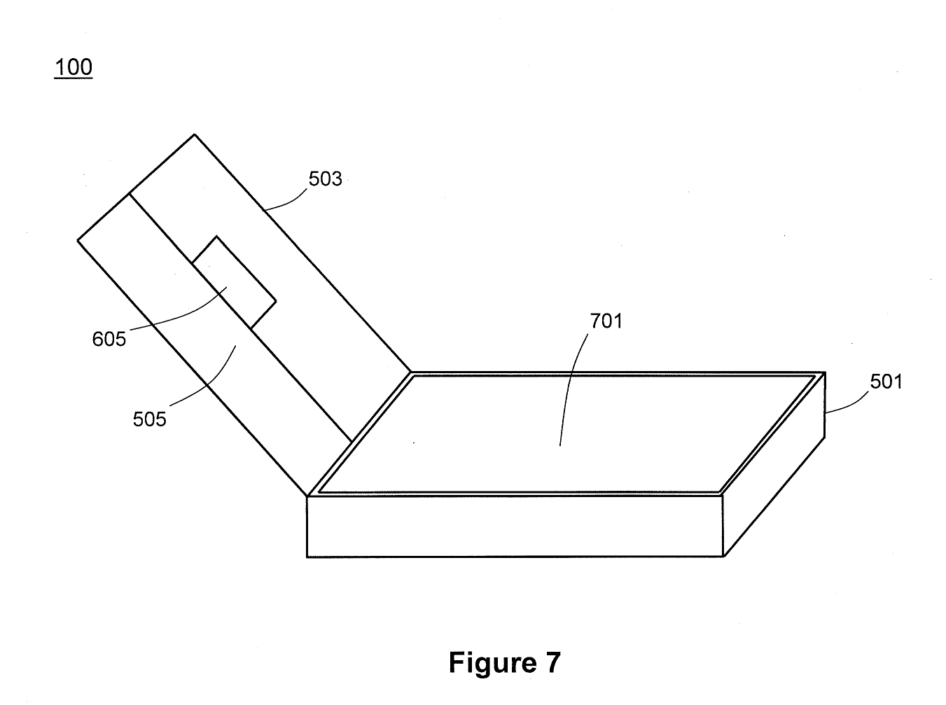

Container 501 further includes insert 507 that occupies at least a portion of the bottom of container 501. Insert 507 can be a hollow or solid object capable of supporting one or more recordable mediums. For example, insert 507 can be formed from cardboard, plastic, metal, a filler material (e.g., wool, polyester fibers, or the like) enclosed within a fabric, or the like (or combinations thereof). In the illustrated embodiment, insert 507 includes recessed portions 509 and 511 configured to secure a recordable medium or sample product. For example, as shown in FIG. 6, a first recordable medium 601 can be secured within recessed portion 509 and a sample product 603 can be secured within recessed portion 511. Additionally, a second recordable medium 605 can be inserted and secured within sleeve 505. As shown in FIG. 7, a third recordable medium 701 can be positioned above first recordable medium 601 and sample product 603.

In one exemplary embodiment, first recordable medium 601 can include a portable computing device, such as a touch-sensitive tablet, cellular phone, or the like. The second recordable medium 605 can include printed materials, such as a booklet, pamphlet, brochure, coupon, application, or the like. In some embodiments, the third recordable medium 701 can also include printed materials, such as a booklet, pamphlet, brochure, coupon, application, or the like. Additionally, in some embodiments, another recordable medium can be attached to, or included within, one of first, second, or third recordable mediums 601, 605, or 701, or container 501. For example, a CD, DVD, Blue-ray disk, or the like, can be affixed (e.g., using an adhesive) to a cover of third recordable medium 701 or inserted within sleeve 505 of cover 503. As described above, some or all of the recordable media (e.g., recordable media 601, 605, and 701) and sample product 603 within container 501 can be configured to identify the client that submitted the RFP. For example, the client's name, logo, color(s), phrase associated with the client, or the like (or combinations thereof), can be affixed to some or all of the recordable media and sample product.

Similar to the examples described above with respect to FIGS. 2-4, each of the recordable media can include information for responding to a specific RFP. For example, if the RFP is requesting proposals for a credit card service, the recordable media can include information regarding the supplier's management team, experience, history, contractual terms, financial bid, and any other information that can be used to describe the supplier's service or product and to distinguish the supplier from other vendors. In some embodiments, each of the recordable media stored in container 501 can be the same. For example, first recordable medium 601 may contain an electronic version of the printed materials of second recordable medium 605 and third recordable medium 701. In some examples, first recordable medium 601 may include an interactive electronic version of the printed materials of second recordable medium 605 and third recordable medium 701. In other embodiments, only a portion of the information stored in the first, second, and third recordable media may be the same. For example, each of the first, second, and third recordable media may include information about the management team and the company history, but some or all of the recordable media may include information that is not included in each of the other recordable media.

While specific embodiments are described above, it should be appreciated that different combinations of recordable media types, container arrangements, and division of information stored on each recordable medium are possible. For example, the system can include other container arrangements having trays configured to secure the various recordable media types. Additionally, while the embodiments described above include three recordable media, it should be appreciated that the systems can be configured to include any number of recordable media.

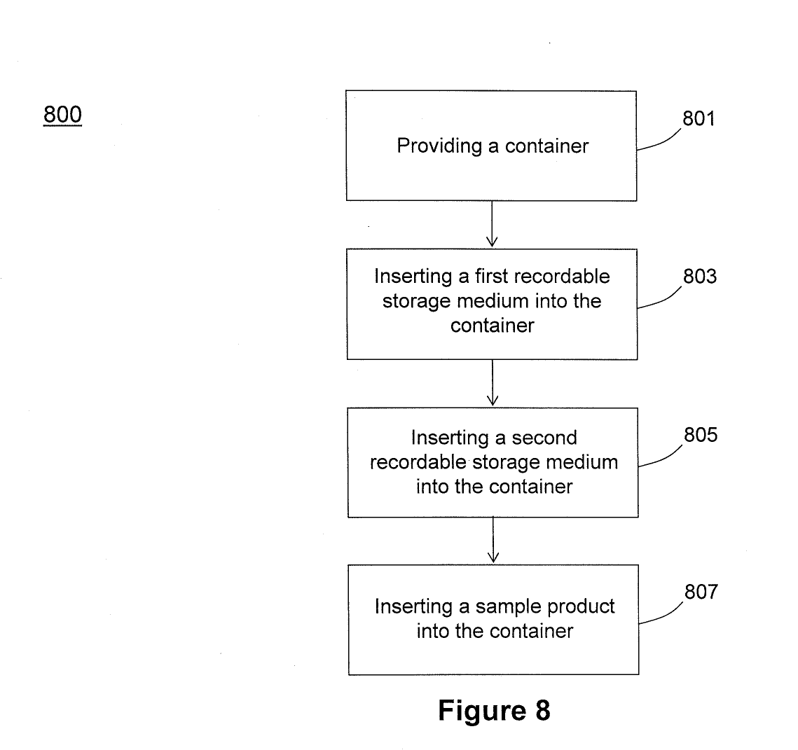

FIG. 8 illustrates an exemplary process 800 for making a system for responding to an RFP. At block 801, a container can be provided. For example, a container similar or identical to containers 101, 201, or 501 can be provided. As described above, the container can be formed from any rigid material, such as cardboard, plastic, metal, or the like, and can be formed into any shape capable of storing multiple recordable media. For example, the container can be a rectangular box, a cylinder, or the like. Alternatively, in other embodiments, the container can be a bag formed from any non-rigid material, such as cotton, nylon, leather, or other materials conventionally used to make bags. Additionally, the container can be configured to identify a client company. For example, the container can include one or more logos (e.g., logo 103) on one or more of its surfaces. The logo can include a graphic design or image, words, or combinations thereof. The logo can be printed onto the container or can be formed from additional materials adhered to the surface of the container to generate the desired design or pattern. Additionally, in some embodiments, the materials used to form the surfaces of the container can be configured to have colors or designs that are associated with the client. For example, the surfaces of the container can be colored using the same colors that the client uses to identify itself (e.g., in its logo or on its products).

At block 803, a first recordable medium can be inserted into the container. For example, a recordable medium similar or identical to recordable medium 301, 401, 601, 605, or 701 can be inserted into the container. As described above, the first recordable medium can include any type of recordable medium, such as printed materials (e.g., a booklet, pamphlet, brochure, coupon, application, or the like), an electronic storage medium (e.g., a CD, DVD, Blue-ray disk, flash memory, or the like), portable electronic media player, or a portable computing device (e.g., touch-sensitive tablet, laptop, or the like).

At block 805, a second recordable medium can be inserted into the container. For example, a recordable medium similar or identical to recordable medium 301, 401, 601, 605, or 701 can be inserted into the container. As described above, the second recordable medium can include any type of recordable medium, such as printed materials (e.g., a booklet, pamphlet, brochure, coupon, application, or the like), an electronic storage medium (e.g., a CD, DVD, Blue-ray disk, flash memory, or the like), portable electronic media player, or a portable computing device (e.g., touch-sensitive tablet, laptop, or the like).

The information contained within each of the first and second recordable media can be for responding to a specific RFP. For example, if the RFP is requesting proposals for a credit card service, the recordable media can include information regarding the supplier's management team, experience, history, contractual terms, financial bid, and any other information that can be used to describe the supplier's service or product and to distinguish the supplier from other vendors. In some embodiments, each of the recordable media stored in the container can be the same. For example, the first recordable medium may contain an electronic version of the printed materials of the second recordable medium. In some examples, the first recordable medium may include an interactive electronic version of the printed materials of the second recordable medium. In other embodiments, only a portion of the information stored in the first and second recordable media may be the same. For example, the first and second recordable media may include information about the contractual terms and the financial bid, but one of the recordable mediums may include information that is not included in the other.

Process 800 can further include the insertion of additional recordable media similar or identical to recordable medium 301, 401, 601, 605, or 701. The information contained within the additional recordable media can be the same as that of the first and second recordable media inserted at blocks 801 and 803. Alternatively, only a portion of the information contained in the additional recordable media may be the same as some or all of the information contained in the first and second recordable media inserted at blocks 801 and 803.

Process 800 can optionally further include block 807. At block 807, a sample product can be inserted into the container. For example, for an RFP for credit card services, the sample product can include a credit card issued to the client and identified with the client's name, logo, color(s), phrase associated with the client, or the like (or combinations thereof). The credit card can be an active credit card that can be used by the client or can be an inactive card provided for the sole purpose of showing the product that would be received if the client engaged in business with the supplier. The product (e.g., a credit card) can be placed anywhere within the container. For example, it can be affixed to one of the recordable mediums or otherwise held in place within the container.

While the blocks of process 800 are shown in a particular order, it should be appreciated that the blocks can be performed in any order. Additionally, one or more of the blocks can be optional and additional blocks can also be performed.

Although a feature may appear to be described in connection with a particular embodiment, one skilled in the art would recognize that various features of the described embodiments may be combined. Moreover, aspects described in connection with an embodiment may stand alone.

What is claimed is:

1. A system for responding to a request for proposal from a client company, the system comprising:
a container configured so as to identify the client company;
a first recordable medium located within the container, the first recordable medium comprising a first set of information for responding to the request for proposal; and
a second recordable medium located within the container, the second recordable medium comprising a second set of information for responding to the request for proposal, wherein the first recordable medium comprises a different type of recordable medium than the second recordable medium.

2. The system of claim 1, wherein the first set of information is the same as the second set of information.

3. The system of claim 1, wherein the first recordable medium and the second recordable medium are configured so as to identify the client company.

4. A system for responding to a request for proposal from a client company, the system comprising:
a container configured so as to identify the client company; and
a plurality of recordable media located within the container, each of the plurality of recordable media storing information for responding to the request for proposal, wherein the recordable media comprises at least two different types of recordable media.

5. The system of claim 4, wherein at least a portion of the information for responding to the request for proposal stored by a first recordable medium of the plurality of recordable media is the same as at least a portion of the information for responding to the request for proposal stored by a second recordable medium of the plurality of recordable media.

6. The system of claim 4, wherein the information for responding to the request for proposal stored by each of the plurality of recordable media is the same.

7. The system of claim 4, wherein the information for responding to the request for proposal comprises one or more of information associated with a company receiving the request for proposal, information associated with a product offered by the company receiving the request for proposal, and projected financial data associated with the client company.

8. The system of claim 4, wherein each of the plurality of recordable media are configured so as to identify the client company and a company receiving the request for proposal.

9. The system of claim 4, wherein the plurality of recordable media comprises at least three different types of recordable media, the at least three different types of recordable media comprising a printed material, a portable computing device, and an electronic storage medium.

10. The system of claim 4, further comprising a sample product configured so as to identify the client company.

11. The system of claim 10, wherein the sample product comprises a credit card attached to one of the plurality of recordable media.

12. The system of claim 4, wherein at least one of the plurality of recordable media is located within another of the plurality of recordable media.

13. The system of claim 4, wherein the container comprises a plurality of support structures, the support structures configured so as to identify the client company.

14. A method for assembling a system for responding to a request for proposal from a client company, the method comprising:
providing a container configured so as to identify the client company;
inserting a first recordable medium into the container, wherein the first recordable medium comprises a first set of information for responding to the request for proposal; and
inserting a second recordable medium into the container, the second recordable medium comprising a second set of information for responding to the request for proposal, wherein the first recordable medium comprises a different type of recordable medium than the second recordable medium.

15. The method of claim 14, wherein the first set of information for responding to the request for proposal comprises the same information as the second set of information for responding to the request for proposal.

16. The method of claim 14, wherein the first set of information for responding to the request for proposal comprises at least a portion of the second set of information for responding to the request for proposal.

17. The method of claim 14 further comprising inserting a sample product into the container, wherein the sample product is configured to identify the client.

18. The method of claim 14 further comprising inserting a third recordable medium into the container, wherein the third recordable medium comprises a third set of information for responding to the request for proposal, the third recordable medium comprising a different type of recordable medium than the first recordable medium and the second recordable medium.

19. The method of claim 18, wherein the third set of information for responding to the request for proposal contains the same information as the first set of information for responding to the request for proposal and the second set of information for responding to the request for proposal.

20. The method of claim 14, wherein the first recordable medium and the second recordable medium are configured so as to identify the client company.
